(19) United States
(12) Patent Application Publication
(10) Pub. No.: US 2014/0064115 A1
(43) Pub. Date: Mar. 6, 2014

(54) BANDWIDTH SELECTION METHOD

(71) Applicant: REAL TEK SEMICONDUCTOR CORP., HsinChu (TW)

(72) Inventors: Wei-Hsuan Chang, Taipei City (TW); Chung-Yao Chang, Hsinchu County (TW)

(73) Assignee: REALTEK SEMICONDUCTOR CORP., HsinChu (TW)

(21) Appl. No.: 13/717,065

(22) Filed: Dec. 17, 2012

(30) Foreign Application Priority Data
Sep. 4, 2012 (TW) 101132195

(51) Int. Cl. H04W 72/08

(52) U.S. Cl. CPC H04W 72/085
USPC 370/252

(57) ABSTRACT

A bandwidth selection method includes capturing at least one first quality information corresponding to a first bandwidth, computing at least one first threshold value according to the at least one first quality information and at least one first weighting index, capturing at least one second quality information corresponding to a second bandwidth, comparing the first threshold value with the second quality information to obtain a first comparison result, and selecting one of the first bandwidth and the second bandwidth as a used bandwidth of a filter according to the first comparison result.

### CROSS-REFERENCES TO RELATED APPLICATIONS

This non-provisional application claims priority under 35 U.S.C. §119(a) on Patent Application No. 101132195 filed in Taiwan, R.O.C. on 2012/09/04, the entire contents of which are hereby incorporated by reference.

### BACKGROUND OF THE INVENTION

1. Technical Field

The present invention relates to a wireless transmission technology, and particularly to a bandwidth selection method.

2. Related Art

Since wireless transmission technologies are applied widely, various signals co-exist and may interfere with wireless transmission, so a wireless router or a base station is generally set to a transmission channel with less interference. However, the wireless transmission environment is ever changing, so a multi-bandwidth operation is required in a wireless transmission system.

In the wireless transmission system, generally, in order to obtain better throughput, a maximum bandwidth allowed in a use specification is selected as a used bandwidth. However, the probability of a narrow band interfering with a large used bandwidth is high. When energy of an interfering signal is high enough, a receiving end receives the interfering signal as a normal packet, but identifies the interfering signal as a false alarm (FA) since the wireless transmission system cannot correctly demodulate the interfering signal. Since the receiving end cannot normally receive a packet when determining the interfering signal as the FA, a normal packet required by the wireless transmission system must be retransmitted, thereby reducing the transmission speed. Here, the transmission quality of the wireless transmission system is affected.

Since the wireless transmission system cannot effectively separate the required normal packet from a packet of the interfering signal, when the wireless transmission system performs demodulation, a demodulation result may be faulty due to a too low signal-to-interference ratio (SIR). Here, transmission power may be increased to increase the SIR, so as to increase the demodulation correctness of the receiving end. However, the cost and benefit must still be considered for high transmission power.

Additionally, a wireless router or base station of the wireless transmission system is located in a changing transmission environment, so noise sent by other communication systems or some electrical appliances often interferes with the wireless router or base station, deteriorating the transmission quality. Therefore, how to avoid the influence caused by the noise interference is one of main areas of research and development in wireless transmission technology.

### SUMMARY

In some embodiments, a bandwidth selection method includes: capturing first quality information corresponding to a first bandwidth; computing a first threshold value according to the first quality information and a first weighting index; capturing second quality information corresponding to a second bandwidth; comparing the first threshold value with a second quality information to obtain a first comparison result; and selecting one of the first bandwidth and the second bandwidth as a used bandwidth of a filter according to the first comparison result.

In some embodiments, a bandwidth selection method includes: capturing at least one first quality information corresponding to one of two distinct bandwidths, and comparing the first quality information with a preset threshold value.

When the first quality information is larger than the preset threshold value, an interference detection procedure is executed. Conversely, when the first quality information is not larger than the preset threshold value, the following steps are executed: selecting a larger one of the bandwidths as the used bandwidth of the filter; reading at least one absolute threshold value; capturing third quality information corresponding to the used bandwidth; comparing the absolute threshold value with the third quality information to obtain a second comparison result; and selectively executing the interference detection procedure according to the second comparison result.

The interference detection procedure includes: obtaining a first threshold value according to the first quality information and a first weighting index; capturing second quality information corresponding to another one of the bandwidths; comparing the first threshold value with the second quality information to obtain a first comparison result; and selecting one of the bandwidths as a used bandwidth of a filter according to the first comparison result.

In sum, in the bandwidth selection method according to the embodiments of the present invention, the used bandwidth of the filter is decided based on signal quality information of each bandwidth, to dynamically select the used bandwidth to reduce the influence caused by ambient noise interference, thereby effectively improving the transmission quality and transmission performance.

### BRIEF DESCRIPTION OF THE DRAWINGS

The disclosure will become more fully understood from the detailed description given herein below for illustration only, and thus not limitative of the present invention, wherein:

FIG. 1 is a schematic diagram of an embodiment of a wireless transmission system;

FIG. 2 is a flow chart of a bandwidth selection method according to a first embodiment of the present invention;

FIG. 3 is a flow chart of a bandwidth selection method according to a second embodiment of the present invention;

FIG. 4 is a detailed flow chart of a first embodiment of an interference detection procedure shown in FIG. 3;

FIG. 5 is a detailed flow chart of a second embodiment of the interference detection procedure shown in FIG. 3;

FIG. 6 is a flow chart of a bandwidth selection method according to a third embodiment of the present invention;

FIG. 7 is a partial flow chart of a bandwidth selection method according to a fourth embodiment of the present invention;

FIG. 8A and FIG. 8B are partial flow charts of a bandwidth selection method according to a fifth embodiment of the present invention;

FIG. 9 is a flow chart of an embodiment for capturing first quality information; and

FIG. 10 is a flow chart of an embodiment for capturing second quality information.

### DETAILED DESCRIPTION

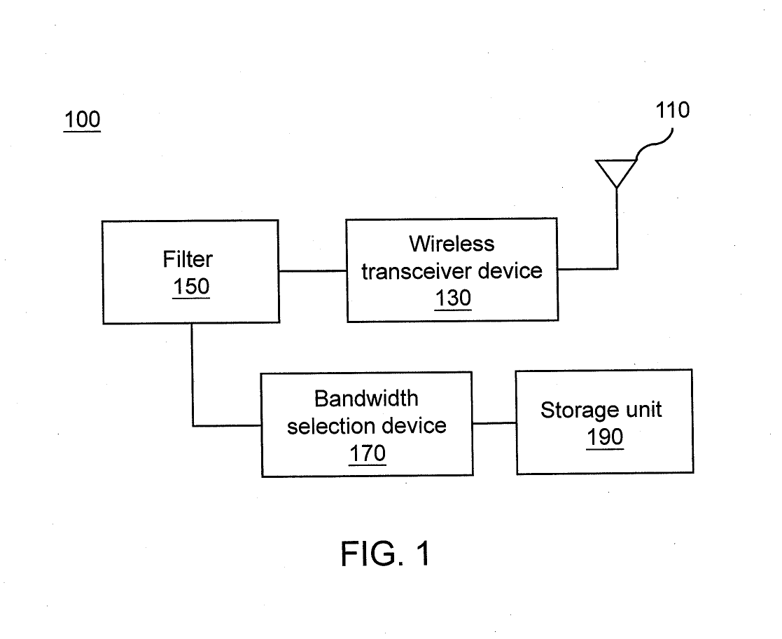

A bandwidth selection method according to any embodiment of the present invention is applicable to a wireless transmission system. FIG. 1 is a schematic diagram of an embodiment of a wireless transmission system. Please referring to FIG. 1, a wireless transmission system 100 includes an antenna 110, a wireless transceiver device 130, a filter 150, a bandwidth selection device 170 and a storage unit 190. In a wireless receiving/sending process, the wireless transceiver device 130 receives/sends a signal via the antenna 110, and the filter 150 filters the signal received by the wireless transceiver device 130. The bandwidth selection device 170 determines a used bandwidth of the filter 150 according to a bandwidth selection method, and correspondingly outputs a control signal to the filter 150, so that the filter 150 switches the used bandwidth thereof.

In some embodiments, the bandwidth selection device 170 may be implemented by one or more processors. The filter 150 may support two kinds of bandwidths (for convenience of description, called a first bandwidth and a second bandwidth hereafter). The first bandwidth is different from the second bandwidth. The storage unit 190 may be implemented by one or more storage elements, and the types of the used storage elements (for example, volatile or non-volatile), are determined according to the types of stored data.

In some embodiments, the bandwidth selection method according to the present invention may be implemented in a software or firmware manner.

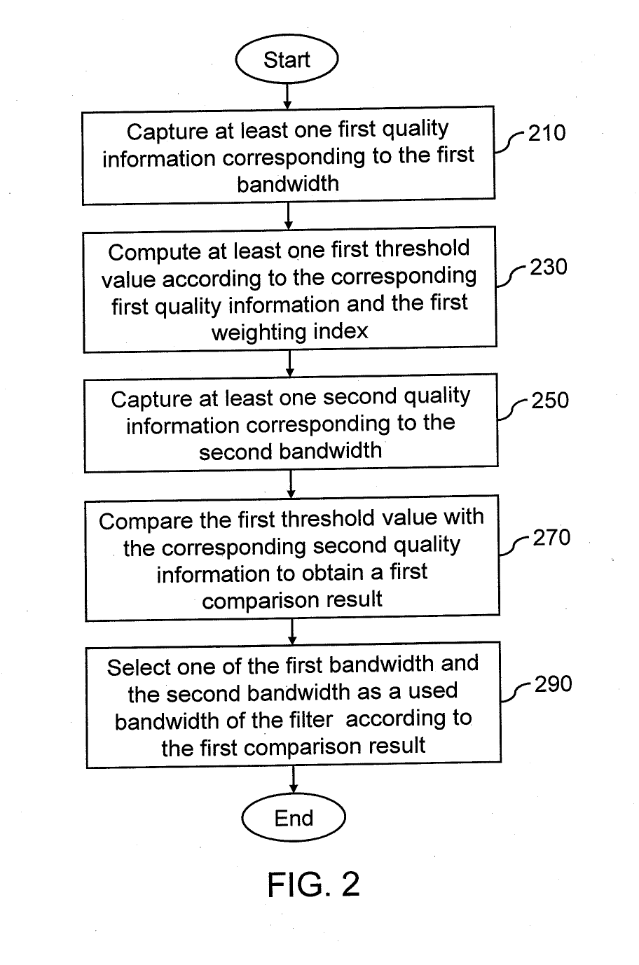

FIG. 2 is a flow chart of a bandwidth selection method according to a first embodiment of the present invention.

Please referring to FIG. 2, the filter 150 switches the used bandwidth to a first bandwidth in response to the control signal from the bandwidth selection device 170, and captures at least one first quality information corresponding to the first bandwidth (Step 210). Additionally, the bandwidth selection device 170 reads first weighting index corresponding to each first quality information from the storage unit 190, and according to the corresponding first quality information and the first weighting index, computes a first threshold value corresponding to each first quality information (Step 230).

Next, the filter 150 switches the used bandwidth to a second bandwidth in response to the control signal from the bandwidth selection device 170, and captures at least one second quality information corresponding to the second bandwidth (Step 250). Here, the type of the second quality information corresponds to the type of the first quality information, so the second quality information also corresponds to the first threshold value.

Next, the bandwidth selection device 170 compares the first threshold value with the corresponding second quality information to obtain a first comparison result (Step 270). Next, one of the first bandwidth and the second bandwidth is selected as a used bandwidth of the filter 150 according to the first comparison result (Step 290).

In this embodiment, although description is provided through one procedure, in fact, Step 210, Step 230, Step 250, Step 270 and Step 290 may be re-executed, or at least one first quality information is captured with the currently used bandwidth (regarded as the first bandwidth) of the filter 150, and Step 230, Step 250, Step 270 and Step 290 are re-executed to dynamically select the used bandwidth of the filter 150, so as to reduce the influence caused by ambient noise interference, thereby effectively improving the transmission quality and transmission performance.

In other words, in some embodiments the wireless transmission system 100 may be set so that the first bandwidth and the second bandwidth are fluctuating values. For example, the first bandwidth may be set to the currently used bandwidth of the filter 150 among two usable bandwidths, and the second bandwidth may be set to the other bandwidth of the two usable bandwidths. In other embodiments, the wireless transmission system 100 also set the first bandwidth and the second bandwidth each to a fixed bandwidth value.

The first quality information is the number of FAs corresponding to the first bandwidth, the number of received packets corresponding to the first bandwidth, the number of clear channel assessments (CCAs) corresponding to the first bandwidth, or a combination thereof. The second quality information is the number of FAs corresponding to the second bandwidth, the number of received packets corresponding to the second bandwidth, the number of CCAs corresponding to the second bandwidth, or a combination thereof. Additionally, different types of first quality information may be set with respective corresponding first weighting indexes. In some embodiments, a manner of selecting the used bandwidth is determined by evaluating whether a transmission environment is clean.

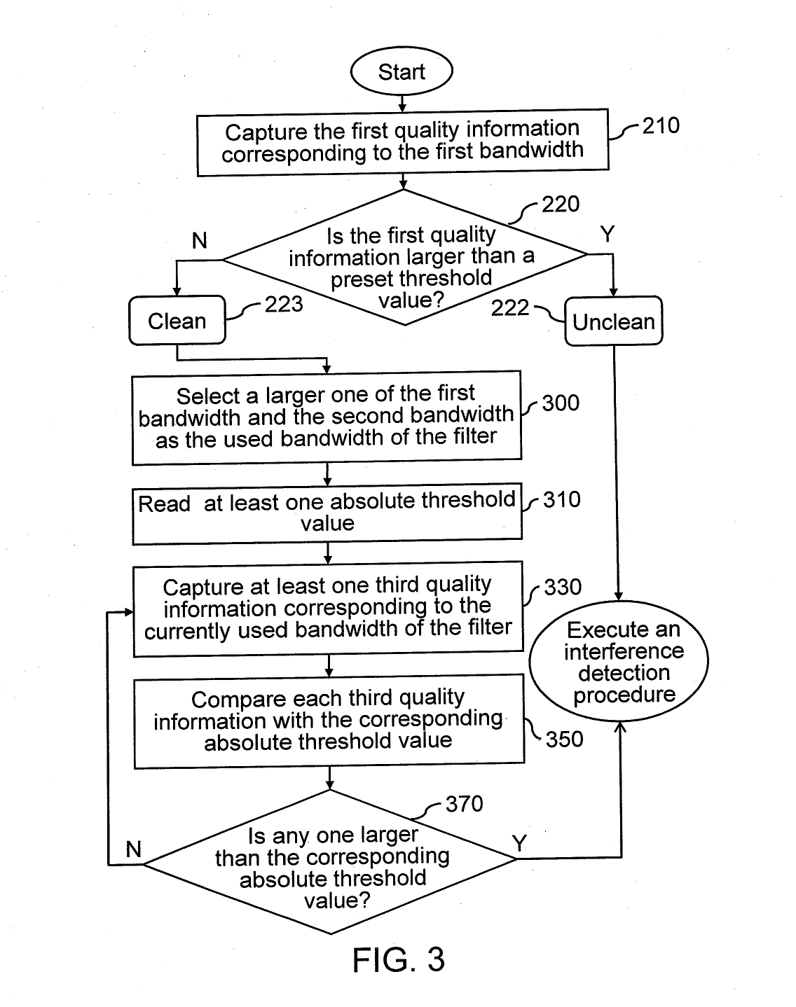

FIG. 3 is a flow chart of a bandwidth selection method according to a second embodiment of the present invention. Please referring to FIG. 3, it is compared whether first quality information is larger than a preset threshold value (Step 220). The preset threshold value is a fixed value set to be stored in the storage unit 190.

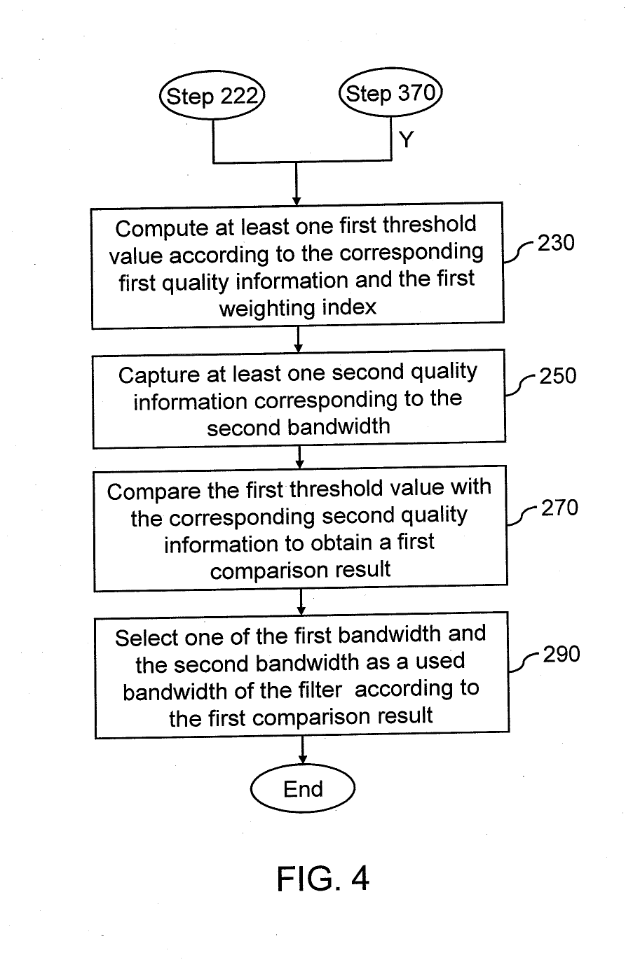

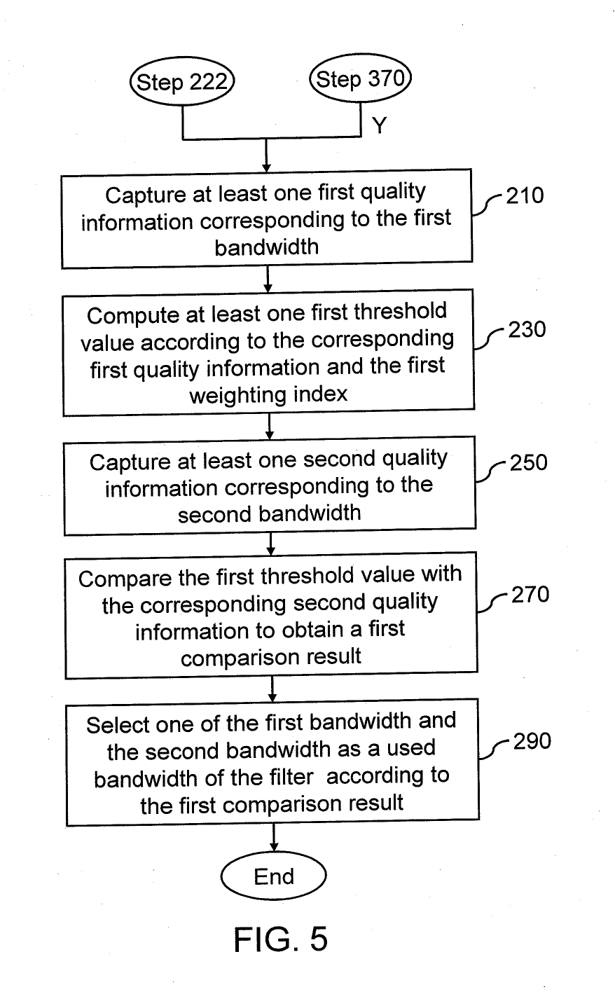

When the first quality information is larger than the preset threshold value, it is determined that the transmission environment is unclean (Step 222), and an interference detection procedure is executed. In the interference detection procedure, Step 230, Step 250, Step 270 and Step 290 may be executed, as shown in FIG. 4. In the interference detection procedure, Step 210 may also be executed again, and then Step 230, Step 250, Step 270 and Step 290 are executed, as shown in FIG. 5.

When the first quality information is not larger than the preset threshold value, it is determined that the transmission environment is clean (Step 223). When the transmission environment is clean, a larger one of the first bandwidth and the second bandwidth is selected as the used bandwidth of the filter 150 (Step 300), and a monitoring procedure for the transmission environment is executed to detect whether interference occurs (that is, to determine whether the transmission environment is changed to be in an unclean state). In the monitoring procedure for the transmission environment, the bandwidth selection device 170 reads at least one absolute threshold value from the storage unit 190 (Step 310), and at least one third quality information corresponding to the currently used bandwidth of the filter 150 is captured by the filter 150 (Step 330). Here, the third quality information corresponds to the absolute threshold value. The bandwidth selection device 170 compares each absolute threshold value with the third quality information corresponding to the absolute threshold value to obtain a second comparison result (Step 350). Next, the bandwidth selection device 170 decides, according to the second comparison result, whether to execute the interference detection procedure (Step 370), that is, decides, according to whether the third quality information is larger than the corresponding absolute threshold value, whether to execute the interference detection procedure. Here, the third quality information compared with the absolute threshold value may be an FA, a CCA, or a combination thereof.

In some embodiments, when any one of the third quality information is larger than the corresponding absolute threshold value, the bandwidth selection device 170 executes the interference detection procedure to re-select the used bandwidth of the filter 150. In this case, the execution of the interference detection procedure may be execution of Step 210, Step 230, Step 250, Step 270 and Step 290, as shown in FIG. 5. Moreover, the execution of the interference detection procedure may also be that the currently used bandwidth of the filter 150 is regarded as the first bandwidth (the third quality information is used as the first quality information), and then the execution of Step 230, Step 250, Step 270 and Step 290 follows, as shown in FIG. 4.

The preset threshold value is used to evaluate whether a certain amount of data information exists in the transmission environment with the used bandwidth of the filter 150. Here, if the transmission environment is unclean, it indicates that a certain amount of data information exists in the transmission environment with the used bandwidth; while if the transmission environment is clean, it indicates that a certain amount of data information does not exist in the transmission environment with the used bandwidth. Therefore, the first quality information for determining a state of the transmission environment may be the number of received packets corresponding to the first bandwidth. For example, the state of the transmission environment is determined according to the number of the packets received by the wireless transmission system 100 with the first bandwidth.

Moreover, each absolute threshold value may be a fixed value set to be stored in the storage unit 190. In some embodiments, the absolute threshold value may be set for the number of FAs corresponding to the larger one of the first bandwidth and the second bandwidth, the number of received packets corresponding to the larger one of the first bandwidth and the second bandwidth, the number of CCAs corresponding to the larger one of the first bandwidth and the second bandwidth, or a combination thereof.

When no third quality information is larger than the corresponding absolute threshold value, a predetermined time later, the procedure returns to Step 330, to re-execute Step 330 and continue to execute subsequent steps. The predetermined time may be a number of seconds, for example, 30 seconds.

Here, a wireless communication system 100 based on the IEEE802.11n communication technology is taken as an example. Usable bandwidths of the filter 150 are 20 MHz and 40 MHz. A bandwidth of 40 MHz is formed by a primary channel of 20 MHz and a secondary channel of 20 MHz.

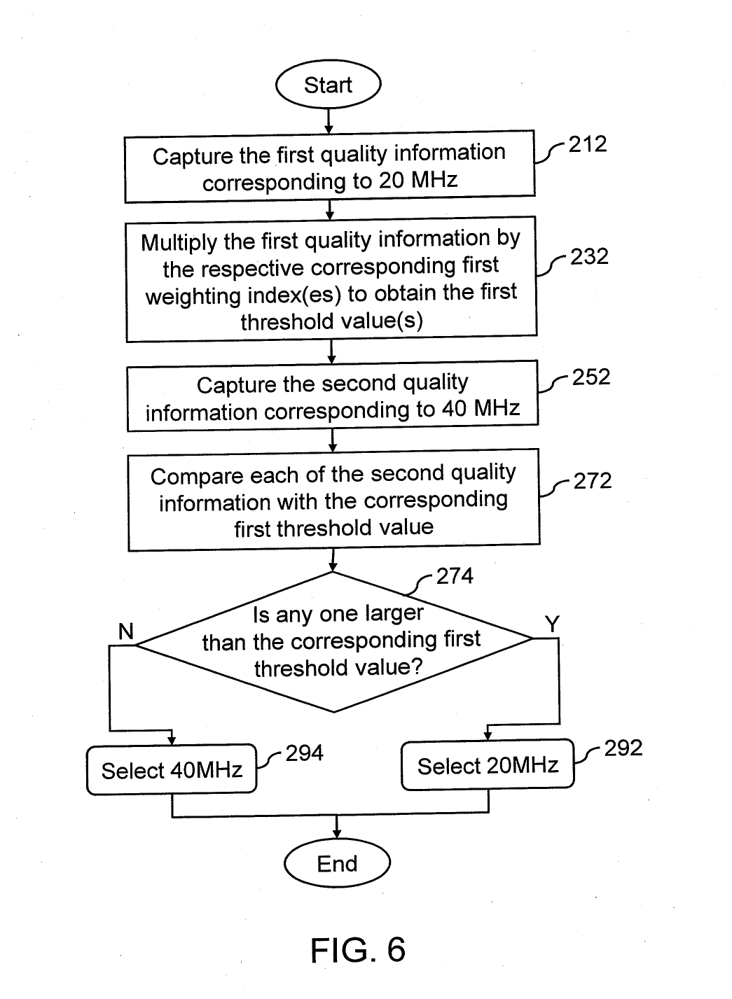

It is assumed that the first bandwidth is 20 MHz and the second bandwidth is 40 MHz, but the present invention is not limited thereto. Please referring to FIG. 6, the bandwidth selection device 170 first controls the used bandwidth of the filter 150 to be 20 MHz, and captures first quality information, where an FA, the number of received packets and a CCA are taken as an example, corresponding to 20 MHz (Step 212). The captured FA corresponding to 20 MHz, the captured number of received packets corresponding to 20 MHz and the captured CCA corresponding to 20 MHz are multiplied by respective corresponding first weighting indexes, to obtain three first threshold values corresponding to the FA, the number of received packets and the CCA, respectively (Step 232).

For example, the FA corresponding to 20 MHz is multiplied by 1.5 to obtain a first threshold value corresponding to the FA; the number of received packets corresponding to 20 MHz is multiplied by 1.5 to obtain a first threshold value corresponding to the number of received packets; and the CCA corresponding to 20 MHz is multiplied by 1.5 to obtain a first threshold value corresponding to the CCA, but the present invention is not limited thereto. Additionally, in the example, the first weighting indexes of different types are set to the same value, but the present invention is not limited thereto, and the first weighting indexes of different types may be set to different values according to actual needs.

Next, the bandwidth selection device 170 controls the filter 150 to switch the used bandwidth to 40 MHz and captures an FA corresponding to 40 MHz, the number of received packets corresponding to 40 MHz, and a CCA corresponding to 40 MHz, that is, the second quality information (Step 252).

Next, the second quality information is compared with a corresponding first threshold value (Step 272). That is to say, the FA corresponding to 40 MHz is compared with a first threshold value obtained by computing the FA corresponding to 20 MHz, the number of received packets corresponding to 40 MHz is compared with a first threshold value obtained by computing the number of received packets corresponding to 20 MHz, and the CCA corresponding to 40 MHz is compared with a first threshold value obtained by computing the CCA corresponding to 20 MHz.

When any second quality information is larger than the corresponding first threshold value (Step 274), it is determined that a used channel of 40 MHz is subject to interference, and is, for example, affected by an adjacent channel or other wireless communication systems. In this case, the bandwidth selection device 170 selects 20 MHz as the used bandwidth of the filter 150 (Step 292), and sends a corresponding control signal to control the filter 150 to switch the used bandwidth to 20 MHz.

When no second quality information is larger than the corresponding first threshold value (Step 274), it is determined that a used channel of 40 MHz is not subject to interference. In this case, the bandwidth selection device 170 selects 40 MHz as the used bandwidth of the filter 150 (Step 294), and sends a corresponding control signal to control the filter 150 to keep the used bandwidth to be 40 MHz.

Here, the first bandwidth of 20 MHz and the second bandwidth of 40 MHz are taken as an example for description, but the present invention is not limited thereto. The first bandwidth may also be set to 40 MHz and the second bandwidth may also be set to 20 MHz according to actual needs, or a currently used bandwidth of the filter 150 is set as the first bandwidth and the other bandwidth is set as the second bandwidth.

In some embodiments, it is assumed that the first bandwidth is 40 MHz and the second bandwidth is 20 MHz. In this case, an FA, the number of received packets and a CCA corresponding to 40 MHz (that is, first quality information), are multiplied by respective corresponding first weighting indexes to obtain a first threshold value corresponding to the FA, a first threshold value corresponding to the number of received packets, and a first threshold value corresponding to the CCA. In this case, the first weighting index may be less than 1 and larger than 0.

Additionally, an FA corresponding to 20 MHz (that is, second quality information), is compared with the first threshold value corresponding to the FA, the number of received packets corresponding to 20 MHz (that is, second quality information), is compared with the first threshold value corresponding to the number of received packets, and a CCA corresponding to 20 MHz (that is, second quality information) is compared with the first threshold value corresponding to the CCA.

Similarly, when any second quality information is larger than the corresponding first threshold value, it is determined that a used channel of 40 MHz is subject to interference, and the bandwidth selection device 170 selects 20 MHz as the used bandwidth of the filter 150. When no second quality information is larger than the corresponding first threshold value, it is determined that a used channel of 40 MHz is not subject to interference, and the bandwidth selection device 170 selects 40 MHz as the used bandwidth of the filter 150.

In some embodiments, the types and the number of pieces of the first quality information and second quality information to be used and the value of the first weighting index may further be determined according to a transmission state of the wireless communication system 100.

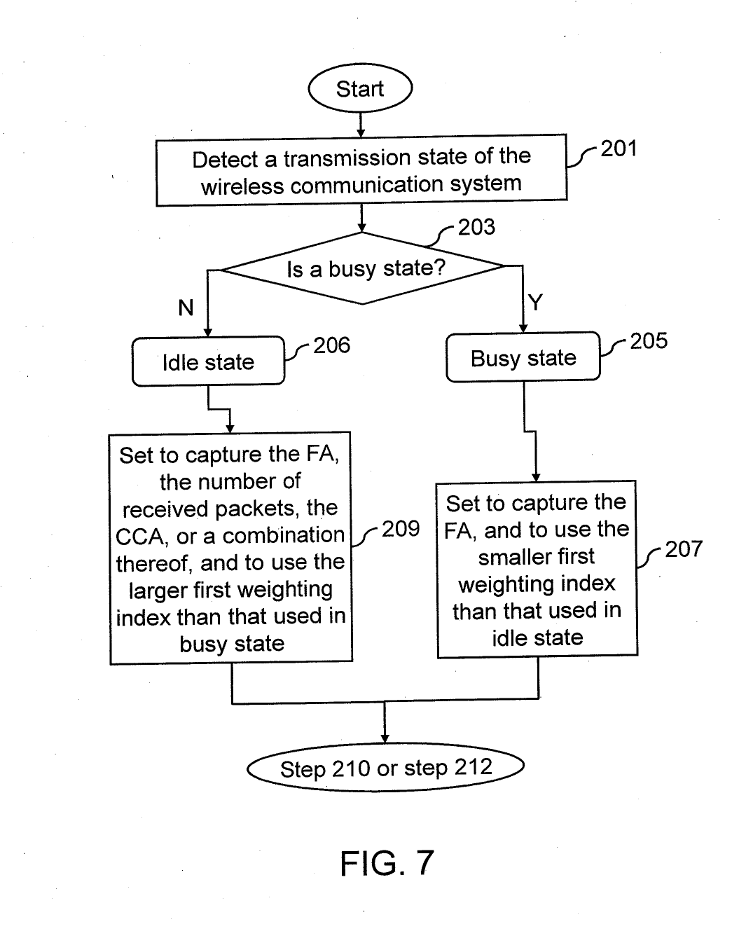

Please referring to FIG. 7, before the first quality information and the second quality information are captured, a transmission state of the wireless communication system 100 is first detected (Step 201), to determine whether the transmission state is a busy state (Step 203). Here, whether the wireless communication system 100 is busy can be determined by detecting a quantity of a wirelessly transmitted data. For example, when the quantity of the wirelessly transmitted data is larger than a preset quantity, the wireless communication system 100 is in a busy state; conversely, when the quantity of the wirelessly transmitted data is not larger than the preset quantity, the wireless communication system 100 is in an idle state.

When the transmission state of the wireless communication system 100 is the busy state (Step 205), the captured first quality information is set to be the FA corresponding to the first bandwidth, and the captured second quality information is set to be the FA corresponding to the second bandwidth (Step 207). Additionally, it is set that a first weighting index being smaller than that used in the idle state is used (Step 207).

When the transmission state of the wireless communication system 100 is the idle state (Step 206), the captured first quality information is set to be the FA corresponding to the first bandwidth, the number of received packets corresponding to the first bandwidth, the CCA corresponding to the first bandwidth, or a combination thereof, and the captured second quality information is set to be the FA corresponding to the second bandwidth, the number of received packets corresponding to the second bandwidth, the CCA corresponding to the second bandwidth, or a combination thereof (Step 209). Additionally, it is set that a first weighting index being larger than that used in the busy state is used (Step 209). Here, the captured first quality information and second quality information may be preferably the FA, the number of received packets and the CCA.

For example, when the wireless communication system 100 is in the busy state, the first weighting index may be 1.5; when the wireless communication system 100 is in the idle state, the first weighting index may be 2.5.

In some embodiments, each of the first quality information includes signal quality information corresponding to a central channel and signal quality information corresponding to a plurality of adjacent channels, and the central channel and the adjacent channels are sorted successively and have the same bandwidth. Each of the second quality information includes signal quality information corresponding to a central channel and signal quality information corresponding to a plurality of adjacent channels, and the central channel and the adjacent channels are sorted successively and have the same bandwidth. The central channel is a channel where a central frequency of a frequency band used by the wireless communication system 100 with the used bandwidth is located. A frequency band of the adjacent channel overlaps with a frequency band of the central channel.

Here, the communication protocol supported by the wireless communication system 100 may be Bluetooth, IEEE802.11a/b/g/n, the home high frequency wireless transmission (home RF), standard, the wireless local area network technology (HiperLan2), the infrared technology, and so on.

An IEEE802.11n wireless communication system 100 is taken as an example. In an ISM wave band of 2.4 GHz, a work frequency segment of the wireless communication system 100 is 2412 MHz to 2472 MHz, which includes a total of 13 channels. The channels are sorted in turn at an interval of 5 MHz. When a central frequency of a used frequency band is 2437 MHz, in a 20 MHz bandwidth mode, a central channel is Ch6 and has a frequency band of 2427 MHz to 2447 MHz. A central frequency of an adjacent channel (Ch7), adjacent to the channel is 2442 MHz, and a frequency band is 2432 MHz to 2452 MHz. The frequency bands of the two have overlapped frequency bands of 15 MHz. The rest may be deduced by analogy. When the wireless communication system 100 uses a 20 MHz bandwidth mode of Ch6, Ch2 to Ch5 and Ch7 to Ch10 are adjacent channels overlapping with Ch6. In a 40

MHz bandwidth mode, a used channel is Ch6, which indicates that the channel is formed by two channels (Ch6 and Ch10), in the 20 MHz bandwidth mode, that is, a frequency band is 2427 MHz to 2467 MHz. In this case, the central channel is Ch8, and adjacent channels overlapping with the central channel include Ch3 to Ch5 and Ch7 to Ch13.

For convenience of description, that the used channel is Ch1, the first bandwidth is 20 MHz, and the second bandwidth is 40 MHz is taken as an example. In the 40 MHz bandwidth mode, a frequency band of the used channel is formed by combining a primary channel (Ch1 in the 20 MHz bandwidth mode), and a secondary channel (Ch5 in the 20 MHz bandwidth mode). In the 40 MHz bandwidth mode, a used frequency band is 2402 MHz to 2442 MHz, and a central frequency is located in Ch3. For the first bandwidth, the central channel is Ch1, and Ch2, Ch3 and Ch4 are all overlapping adjacent channels. For the second bandwidth, a central channel is Ch3, and Ch1, Ch2, Ch4, Ch6, Ch7 and Ch8 are all overlapping adjacent channels.

Please referring to Table 1, when the first quality information and the second quality information are computed according to the number of received packets, the first quality information corresponding to 20 MHz is a sum of the numbers of received packets captured in Ch1, Ch2, Ch3 and Ch4, and the second quality information corresponding to 40 MHz is a sum of the numbers of received packets captured in Ch1, Ch2, Ch3, Ch4, Ch5, Ch6, Ch7 and Ch8. Here, suppose that the first weighting index is set to 1.5, calculation is performed according to the first quality information to obtain the first threshold value being 51. Further, it is obtained after comparison that the second quality information is larger than the first threshold value (220>51), so 20 MHz is selected as the used bandwidth.

TABLE 1

| Channel | Ch1 | Ch2 | Ch3 | Ch4 | Ch5 | Ch6 | Ch7 | Ch8 |
|---|---|---|---|---|---|---|---|---|
| The number | 10 | 6 | 8 | 10 | 5 | 8 | 167 | 6 |
| of received | | | | | | | | |
| packets | | | | | | | | |

| | |
|---|---|
| First quality | Q20 = 10 + 6 + 8 + 10 = 34 |
| information | |
| Second quality | Q40 = 10 + 6 + 8 + 10 + 5 + 8 + 107 + 6 = 220 |
| information | |
| First threshold | 34*1.5 = 51 |
| value | |

In some embodiments, different weighting values are given to signal quality information of adjacent channels according to the size of overlapped frequency bands between each adjacent channel and the central channel. For example, the smaller the frequency band overlapping with the central channel is, the smaller the given weighting value is; conversely, the larger the frequency band overlapping with the central channel is, the larger the given weighting value is. The weighting value is a multiple less than or equal to 1 and larger than 0.

In other words, each of the first quality information includes signal quality information corresponding to the central channel and signal quality information with respective weighting values corresponding to the adjacent channels, where the central channel and the adjacent channels are sorted successively and have the same bandwidth. Each of the second quality information includes signal quality information corresponding to the central channel and signal quality information with respective weighting values corresponding to the adjacent channels, where the central channel and the adjacent channels are sorted successively and have the same bandwidth.

The central channel is a channel where a central frequency of a frequency band used by the wireless communication system 100 with the used bandwidth is located. The adjacent channel may be a channel overlapping with the frequency band of the central channel. Additionally, the adjacent channels may also be a certain number of channels adjacent to the central channel, that is, a certain number of channels preceding and following the central channel. For example, a certain number of channels preceding and following the central channel are one channel preceding the central channel and one channel following the central channel, or two channels preceding the central channel and two channels following the central channel.

For example, referring to Table 2, it is assumed that a weighting value of a first adjacent channel is 0.8 (W1), a weighting value of a second adjacent channel is 0.6 (W2), and a weighting value of a third adjacent channel and remaining adjacent channels is 0.4 (W1). For the first bandwidth of 20 MHz, the numbers of received packets captured by the adjacent channels (Ch2, Ch3 and Ch4) are first multiplied by the weighting values of the adjacent channels respectively, then products and the number of received packets captured by the central channel (Ch1) are added up, to obtain the first quality information being 23.6.

Similarly, for the second bandwidth of 40 MHz, the numbers of received packets captured by the adjacent channels (Ch1, Ch2, Ch4, Ch5, Ch6, Ch7 and Ch8) are first multiplied by the weighting values of the adjacent channels respectively, then products and the number of received packets captured by the central channel (Ch3) are added up, to obtain the second quality information being 102.2. Here, suppose that the first weighting index is set to 1.5, calculation is performed according to the first quality information to obtain the first threshold value being 35.4. Since the second quality information exceeds the first threshold value, so 20 MHz is selected as the used bandwidth.

TABLE 2

| Channel | Ch1 | Ch2 | Ch3 | Ch4 | Ch5 | Ch6 | Ch7 | Ch8 |
|---|---|---|---|---|---|---|---|---|
| The number | 10 | 6 | 8 | 10 | 5 | 8 | 167 | 6 |
| of received | | | | | | | | |
| packets | | | | | | | | |

| | |
|---|---|
| First quality | Q20 = 10 + 6 × W1 + 8 × W2 + 10 × W3 = 23.6 |
| information | |
| Second quality | Q40 = 8 + (6 + 10) × W1 + (10 + 5) × W2 + (8 + |
| information | 167 + 6) × W3 = 102.2 |
| First threshold | 23.6 × 1.5 = 35.4 |
| value | |

In some embodiments, after the used bandwidth is selected, the interference detection procedure may be re-executed after the predetermined time, to monitor interference change in a transmission environment. The predetermined time may be a time threshold stored in the storage unit 190.

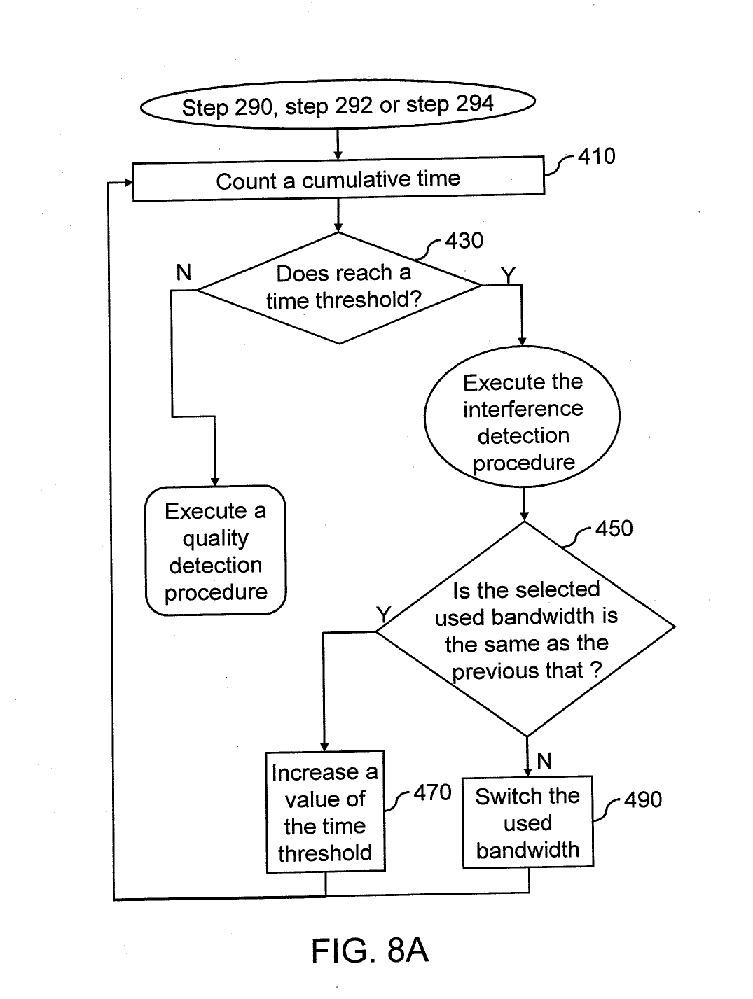

Please referring to FIG. 8A, after the used bandwidth is selected (Step 290, Step 292, or Step 294), a cumulative time is counted (Step 410), and it is determined whether the cumulative time reaches a time threshold (Step 430).

When the cumulative time reaches the time threshold in Step 430, the interference detection procedure is re-executed. Here, the re-execution of the interference detection procedure may be that a currently used bandwidth of the filter 150 is regarded as the first bandwidth (the third quality information may be used as the first quality information), and execution of Step 230, Step 250, Step 270 and Step 290 follows. Moreover, the re-execution of the interference detection procedure may also be re-execution of Step 210, Step 230, Step 250, Step 270 and Step 290.

Moreover, after the re-execution of the interference detection procedure, it is determined whether the selected used bandwidth is the same as a selection result obtained last time (Step 450). In other words, after the re-execution of the interference detection procedure, it is determined whether the filter 150 shall switch the used bandwidth.

When the selected used bandwidth is the same as the selection result obtained last time (Step 450), that is, the filter 150 does not switch the used bandwidth, a value of the time threshold is increased (Step 470). In some embodiments, the value of the time threshold may be increased by an arithmetic progression or geometric progression. Additionally, the geometric progression may be from small to large.

When the cumulative time does not reach the time threshold in Step 430, a quality detection procedure is executed, to monitor, at any time, whether signal quality of the used bandwidth has changed.

Please referring to FIG. 8B, in the quality detection procedure, at least one third threshold value is obtained (Step 510), and the filter 150 captures at least one third quality information corresponding to the used bandwidth (Step 530). Here, the third quality information corresponds to the third threshold value.

after the used bandwidth is selected (Step 290, Step 292 or Step 294), the third threshold value may be computed according to the quality information corresponding to the selected bandwidth and a second weighting index, and the third threshold value obtained through calculation is stored in the storage unit 190. In Step 510, the bandwidth selection device 170 reads the third threshold value from the storage unit 190.

For example, when the first bandwidth is selected as the used bandwidth in Step 290, Step 292 or Step 294, for the type of quality information, each type of first quality information is multiplied by the corresponding second weighting index thereof to obtain a third threshold value of each type of quality information. When the second first bandwidth is selected as the used bandwidth in Step 290, Step 292 or Step 294, each type of second quality information is multiplied by the corresponding second weighting index thereof to obtain a third threshold value of each type of quality information.

The bandwidth selection device 170 compares each third threshold value with the corresponding third quality information to obtain a third comparison result (Step 550). Then, it is determined, according to the third comparison result, whether to execute the interference detection procedure (Step 570).

When the used bandwidth selected in Step 290, Step 292 or Step 294 is a relatively small bandwidth (for example, 20 MHz of 20 MHz and 40 MHz), the second weighting index is less than 1, and in Step 550, it is decided, by determining whether the third quality information is less than the corresponding third threshold value, whether to execute the interference detection procedure. In other words, when any one type of the third quality information is less than the corresponding third threshold value, the interference detection procedure is re-executed. Conversely, when no third quality information is less than the corresponding third threshold value, the procedure returns to Step 410.

When the used bandwidth selected in Step 290, Step 292 or Step 294 is a relatively large bandwidth (for example, 40 MHz of 20 MHz and 40 MHz), the second weighting index is larger than 1, and in Step 550, it is decided, by determining whether the third quality information is larger than the corresponding third threshold value, whether to execute the interference detection procedure. In other words, when any one type of the third quality information is larger than the corresponding third threshold value, the interference detection procedure is re-executed. Conversely, when no third quality information is larger than the corresponding third threshold value, the procedure returns to Step 410.

Additionally, the third quality information compared with the third threshold value may be an FA, a CCA, the number of received packets or a combination thereof.

In some embodiments, in Step 210, Step 212, Step 250, Step 252 and Step 330, corresponding quality information may be obtained by analyzing a streaming signal received in the currently used bandwidth of the filter 150.

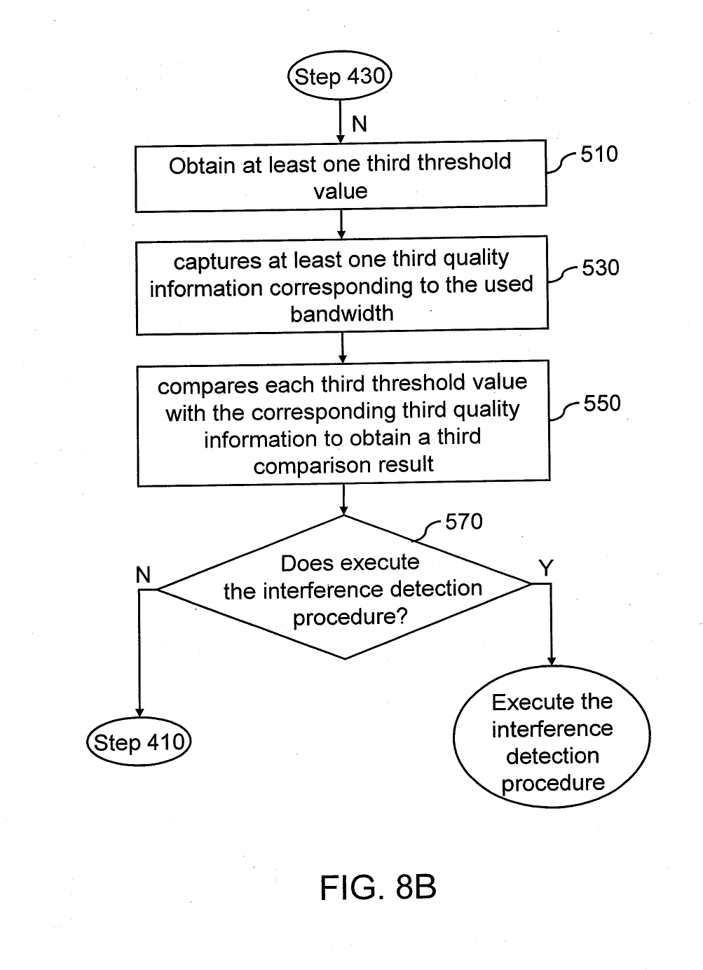

Please referring to FIG. 9, the first quality information is taken as an example. First, the used bandwidth of the filter 150 is set as the first bandwidth (Step 213), so that the filter 150 uses the first bandwidth as a currently used bandwidth. The wireless transceiver device 130 receives a first streaming signal with the first bandwidth via an antenna 110 (Step 215). The bandwidth selection device 170 obtains the first quality information by analyzing the first streaming signal (Step 217).

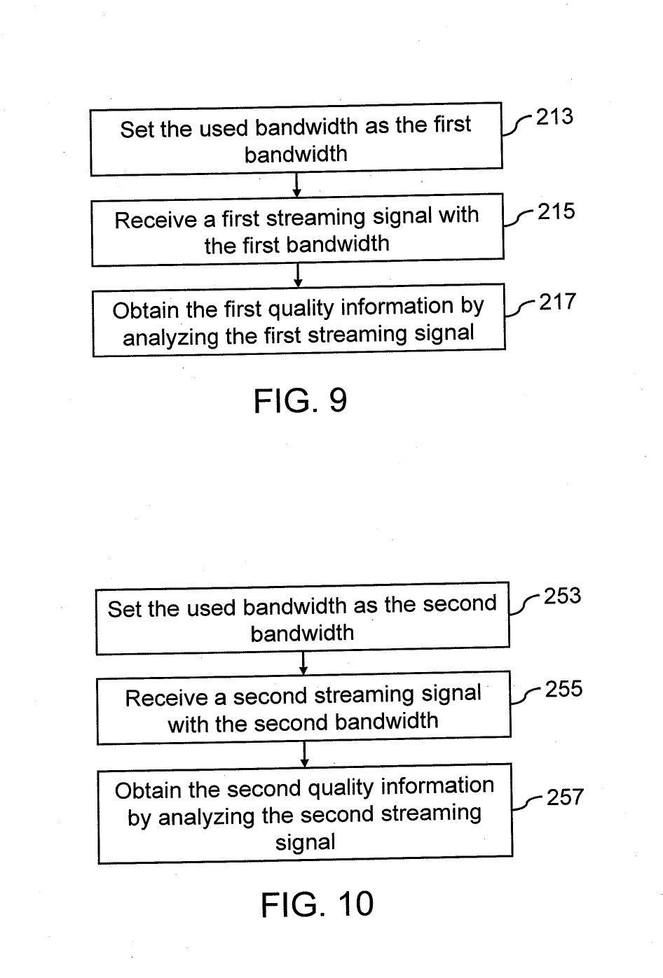

Please referring to FIG. 10, the second quality information is taken as an example. First, the used bandwidth of the filter 150 is set as the second bandwidth (Step 253), so that the filter 150 uses the second bandwidth as a currently used bandwidth. The wireless transceiver device 130 receives a second streaming signal with the second bandwidth via an antenna 110 (Step 255). The bandwidth selection device 170 obtains the second quality information by analyzing the second streaming signal (Step 257).

It should be understood that, the execution order of the steps is not limited to the order described in the foregoing embodiments, and the execution order can be appropriately adjusted according to the execution content of the steps. For example, the second quality information only must be captured (Step 250) before being compared with the first threshold value (Step 270), and it is not limited that the capturing is executed after the first threshold value is computed (Step 230). That is to say, Step 250 can be executed between Step 230 and Step 270, or before Step 210, or between Step 210 and Step 230, or together with Step 230.

In sum, in the bandwidth selection method according to the embodiments of the present invention, the used bandwidth of the filter is dynamically decided according to the signal quality information of each bandwidth, to dynamically select one of the usable bandwidths as the currently used bandwidth, thereby reducing the influence caused by ambient noise interference, and further, effectively improving the transmission quality and transmission performance. For example, when the interference is narrow band interference or a frequency band overlapping with other wireless communication systems is very small, the bandwidth selection method according to the embodiments of the present invention can dynamically adjust the used bandwidth to reduce the used frequency band, and suppress the interference energy by means of the filter, so as to provide a signal-to-interference power ratio.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A bandwidth selection method, comprising:
capturing at least one first quality information corresponding to a first bandwidth;
computing at least one first threshold value according to the at least one first quality information and at least one first weighting index;
capturing at least one second quality information corresponding to a second bandwidth;
comparing the at least one first threshold value with the at least one second quality information to obtain a first comparison result; and
selecting one of the first bandwidth and the second bandwidth as a used bandwidth of a filter according to the first comparison result.

2. The bandwidth selection method according to claim 1, wherein the step of capturing the at least one first quality information comprises:
setting the used bandwidth to the first bandwidth;
receiving a first streaming signal corresponding to the first bandwidth; and
obtaining the at least one first quality information by analyzing the first streaming signal.

3. The bandwidth selection method according to claim 1, wherein the step of capturing the at least one second quality information comprises:
setting the used bandwidth to the second bandwidth;
receiving a second streaming signal corresponding to the second bandwidth; and
obtaining the at least one second quality information by analyzing the second streaming signal.

4. The bandwidth selection method according to claim 1, further comprising:
after the selecting step, counting a cumulative time according to a time threshold; and
when the cumulative time reaches the time threshold, re-executing the step of capturing the at least one first quality information, the step of obtaining the at least one first threshold value, the step of capturing the at least one second quality information, the comparing step and the selecting step.

5. The bandwidth selection method according to claim 4, further comprising: when the used bandwidth selected in the current selecting step is the same as the used bandwidth selected in the previous selecting step, increasing a value of the time threshold.

6. The bandwidth selection method according to claim 4, further comprising:
when the cumulative time does not reach the time threshold, detecting quality of a received signal, the detecting step comprising:
when the first bandwidth is selected in the selecting step, computing at least one third threshold value according to at least one second weighting index and the at least one first quality information;
when the second bandwidth is selected in the selecting step, computing at least one third threshold value according to at least one third weighting index and the at least one second quality information;
capturing at least one third quality information corresponding to the used bandwidth;
comparing the at least one third threshold value with at least one third quality information to obtain a second comparison result; and
according to the second comparison result, selectively re-executing the step of capturing the at least one first quality information, the step of obtaining the at least one first threshold value, the step of capturing the at least one second quality information, the comparing step and the selecting step.

7. The bandwidth selection method according to claim 1, further comprising:
detecting a transmission state of a wireless communication system with the filter; and
when the transmission state is a busy state, the at least one first quality information being the number of false alarms (FAs) corresponding to the first bandwidth, and the at least one second quality information being the number of FAs corresponding to the second bandwidth,
wherein the at least one first weighting index when the transmission state is the busy state is less than the at least one first weighting index when the transmission state is an idle state.

8. The bandwidth selection method according to claim 1, wherein the at least one first quality information is at least one of the number of FAs corresponding to the first bandwidth, the number of received packets corresponding to the first bandwidth, and the number of clear channel assessments (CCAs) corresponding to the first bandwidth, and the at least one second quality information is at least one of the number of FAs corresponding to the second bandwidth, the number of received packets corresponding to the second bandwidth, and the number of CCAs corresponding to the second bandwidth.

9. The bandwidth selection method according to claim 1, wherein in the capturing steps, any of the first quality information and the second quality information comprises signal quality information corresponding to a used channel and signal quality information corresponding to a plurality of adjacent channels, and the used channel and the adjacent channels are sorted successively and have the same bandwidth.

10. The bandwidth selection method according to claim 9, wherein frequency bands of the adjacent channels overlap with a frequency band of the central channel.

11. The bandwidth selection method according to claim 1, wherein in the capturing steps, any of the first quality information and the second quality information comprises signal quality information corresponding to a central channel and signal quality information with respective weighting values corresponding to a plurality of adjacent channels, and the central channel and the adjacent channels are sorted successively and have the same bandwidth.

12. The bandwidth selection method according to claim 11, wherein frequency bands of the adjacent channels overlap with a frequency band of the central channel.

13. The bandwidth selection method according to claim 1, wherein in the step of computing the at least one first threshold value, the at least one first threshold value is a product of the at least one first weighting index and the corresponding at least one first quality information.

14. The bandwidth selection method according to claim 1, wherein the first bandwidth is less than the second bandwidth.

15. The bandwidth selection method according to claim 1, wherein the second bandwidth is less than the first bandwidth.

16. A bandwidth selection method, comprising:
capturing at least one first quality information corresponding to one of two bandwidths, wherein the bandwidths are of distinct values;
comparing one of the at least one first quality information with a preset threshold value;
when the first quality information is larger than the preset threshold value, executing an interference detection procedure, the interference detection procedure comprising:
obtaining at least one first threshold value according to the at least one first quality information and at least one first weighting index;
capturing at least one second quality information corresponding to another one of the bandwidths;
comparing the at least one first threshold value with at least one second quality information to obtain a first comparison result; and
selecting one of the bandwidths as a used bandwidth of a filter according to the first comparison result; and
when the first quality information is not larger than the preset threshold value, the method further comprising:
selecting a larger one of the bandwidths as the used bandwidth of the filter;
reading at least one absolute threshold value;
capturing at least one third quality information corresponding to the used bandwidth;
comparing the at least one absolute threshold value with the at least one third quality information to obtain a second comparison result; and
selectively executing the interference detection procedure according to the second comparison result.

17. The bandwidth selection method according to claim 16, wherein the interference detection procedure further comprises:
after the selecting step, counting a cumulative time according to a time threshold; and
when the cumulative time reaches the time threshold, re-executing the interference detection procedure.

18. The bandwidth selection method according to claim 17, wherein the interference detection procedure further comprises: when the used bandwidth selected in the current selecting step is the same as the used bandwidth selected in the previous selecting step last time, increasing a value of the time threshold.

19. The bandwidth selection method according to claim 17, wherein the interference detection procedure further comprises:
when the cumulative time does not reach the time threshold, executing a quality detection procedure, wherein the quality detection procedure comprises:
obtaining at least one third threshold value, wherein the at least one third threshold value is obtained by computing at least one of the at least one first quality information and the at least one second quality information, that is corresponding to the bandwidth selected in the selecting step, and at least one second weighting index;
capturing at least one third quality information corresponding to the used bandwidth;
comparing the at least one third threshold value with at least one third quality information to obtain a third comparison result; and
according to the third comparison result, re-executing the interference detection procedure, or returning to the step of capturing the at least one first quality information and re-executing each of the steps.

20. The bandwidth selection method according to claim 16, further comprising:
detecting a transmission state of a wireless communication system with the filter; and
when the transmission state is a busy state, the at least one first quality information used in the interference detection procedure being the number of false alarms (FAs) corresponding to one of the bandwidths, and the at least one second quality information being the number of FAs corresponding to the other one of the bandwidths,
wherein the at least one first weighting index when the transmission state is the busy state is less than the at least one first weighting index when the transmission state is an idle state.

21. The bandwidth selection method according to claim 20, wherein when the transmission state is not the busy one, the at least one first quality information is the number of FAs corresponding to the one of the bandwidths, the number of received packets corresponding to the one of the bandwidths, the number of clear channel assessments (CCAs) corresponding to the one of the bandwidths, or a combination thereof, and the at least one second quality information is the number of FAs corresponding to the other one of the bandwidths, the number of received packets corresponding to the other one of the bandwidths, the number of CCAs corresponding to the other one of the bandwidths, or a combination thereof.

22. The bandwidth selection method according to claim 16, wherein in the capturing steps, any of the first quality information, the second quality information and the third quality information comprises signal quality information corresponding to a central channel and signal quality information corresponding to a plurality of adjacent channels, and the central channel and the adjacent channels are sorted successively and have the same bandwidth.

23. The bandwidth selection method according to claim 22, wherein frequency bands of the adjacent channels overlap with a frequency band of the central channel.

24. The bandwidth selection method according to claim 16, wherein in the capturing steps, any of the first quality information, the second quality information and the third quality information comprises signal quality information corresponding to a central channel and signal quality information with respective weighting values corresponding to a plurality of adjacent channels, and the central channel and the adjacent channels are sorted successively and have the same bandwidth.

25. The bandwidth selection method according to claim 24, wherein frequency bands of the adjacent channels overlap with a frequency band of the central channel.

26. The bandwidth selection method according to claim 16, wherein in the step of computing the at least one first threshold value, the at least one first threshold value is a product of the at least one first weighting index and the corresponding at least one first quality information.
